(19) United States
(12) Patent Application Publication
(10) Pub. No.: US 2014/0168560 A1
(43) Pub. Date: Jun. 19, 2014

(54) LIQUID CRYSTAL DISPLAY DEVICE, METHOD OF DRIVING LIQUID CRYSTAL DISPLAY DEVICE, AND METHOD OF ADJUSTING PULSE WAVEFORM SIGNAL

(71) Applicant: Ryo Yamakawa, Osaka-shi (JP)

(72) Inventor: Ryo Yamakawa, Osaka-shi (JP)

(73) Assignee: SHARP KABUSHIKI KAISHA, Osaka-shi, Osaka (JP)

(21) Appl. No.: 14/131,513

(22) PCT Filed: Jul. 9, 2012
(86) PCT No.: PCT/JP2012/067441

§ 371 Date: Jan. 8, 2014

(30) Foreign Application Priority Data
Jul. 13, 2011 (JP) 2011-154718

(51) Int. Cl. G02F 1/1362

(52) U.S. Cl. CPC G02F 1/136213
USPC 349/43; 349/42

(57) ABSTRACT

A liquid crystal display device according to the present invention includes a plurality of storage capacitor lines and a storage capacitor drive circuit. The storage capacitor lines are connected to the respective storage capacitors. The storage capacitor drive circuit generates storage capacitor signals CSs1, CSs2 applied to the storage capacitors via the storage capacitor lines. Waveforms of the storage capacitor signals CSs1 and CSs2 in a vertical blanking interval K2 of image display is pulse waveforms. Each waveform includes an upper waveform region in which a signal level is higher than a mean voltage Vcom and a lower waveform region in which the signal level is lower than the mean voltage Vcom. The waveform further includes at least one of an overshoot section (period T1) in which the storage capacitor signal overshoots the maximum value VCSH of the pulse waveform and an undershoot section in which the storage capacitor signal undershoots the maximum value of the pulse waveform for equalizing effective values in the upper waveform region and in the lower waveform region.

### TECHNICAL FIELD

The present invention relates to a liquid crystal display device, a method of driving liquid crystal display device, and a method of adjusting pulse waveform signals, especially to a technology for adjusting a waveform of a storage capacitor signal for driving a storage capacitor in a liquid crystal display device in which display pixels include storage capacitors.

### BACKGROUND ART

Technology for adjusting waveforms of storage capacitance signals in liquid crystal devices, such as a technology disclosed in Patent Document 1, have been known. Patent Document 1 discloses a technology for reducing uneven brightness in a liquid crystal display device related to a storage capacitance line by adjusting a waveform of a storage capacitance signal. A rising edge and a falling edge of the waveform are overshot. The storage capacitance signal is for driving a storage capacitor.

### RELATED ART DOCUMENT

### Patent Document

Patent Document 1: Japanese Unexamined Patent Application Publication No. 2009-63938

### Problem to be Solved by the Invention

The technology disclosed in Patent Document 1 can properly reduce uneven brightness in the liquid crystal display device related to the storage capacitance line with the storage capacitance signal having overshooting regions. However, Patent Document 1 does not disclose a storage capacitance signal in a flyback period at display timing in the liquid crystal display device. In general, flyback periods in liquid crystal display devices may differ from one another due to differences in display specifications of the liquid crystal display devices. Further, in design of time axes of capacitance signals, the time axes may be determined depending on gate signals (scanning line signals). Namely, design may be limited in terms of timing and it is not easy to accurately design the timing of the storage capacitance signal when the design is limited as such.

If a storage capacitance signal adjusted appropriate for a flyback period in a liquid crystal display device is applied to another liquid crystal display device, a time difference that is difficult to adjust may occurs. For example, as illustrated in FIG. 5, such a time difference is observed between a period W1 in which a voltage is higher than a common electrode voltage Vcom (a mean voltage during AC driving) and a period W2 in which a voltage is lower than the common electrode voltage Vcom. Due to the time difference, symmetry of the storage capacitance signal about the mean voltage collapses, which may be a cause of uneven brightness. Therefore, a technology for reducing uneven brightness due to the storage capacitance signal in the flyback period with a simple method has been expected.

### DISCLOSURE OF THE PRESENT INVENTION

The present invention was made in view of the foregoing circumstances. An object of the present invention is to provide a technology for properly conducting an adjustment of an effective value of a pulse waveform signal in a predetermined period and reducing uneven brightness resulting from a storage capacitor signal in a blanking interval with a simply method.

### Means for Solving the Problem

To resolve the above problems, a liquid crystal display device according to the present invention includes a plurality of data signal lines, a plurality of scanning signal lines, a plurality of storage capacitor lines, and a storage capacitor drive circuit. The pixels are arranged close to respective intersections of the data signal lines and the scanning signal lines. The pixels include transistors, pixel electrodes connected to the transistors, and storage capacitors. The storage capacitor lines are connected to the respective storage capacitors. The storage capacitor drive circuit is configured to generate storage capacitor signals applied to the respective storage capacitors via the storage capacitor lines. A waveform of each storage capacitor signal in a vertical blanking interval of image display is a pulse waveform including an upper waveform region in which a signal level is higher than a mean voltage of the storage capacitor signal and a lower waveform region in which the signal level is lower than mean voltage. The waveform of each storage capacitor signal includes at least one of an overshoot section in which the storage capacitor signal overshoots the maximum value of the pulse waveform and an undershoot section in which the storage capacitor signal undershoots the maximum value of the pulse waveform for equalizing effective values in the upper waveform region and in the lower waveform region.

According to this configuration, the waveform of the storage capacitor signal in the blanking interval is formed with at least one of the overshoot section and the undershoot section to equalize effective values in the upper waveform region and in the lower waveform region. Therefore, uneven brightness resulting from the storage capacitor signal in the blanking period can be reduced with a simple method. The meaning of the phrase “to equalize effective values” includes “substantially equalize effective values.” The phrase “the maximum value of the pulse waveform” means an absolute value from the mean voltage.

In the above configuration, the storage capacitor signal in the vertical blanking interval may include a first frequency section with a predetermined frequency and a second frequency section with a frequency higher than the frequency of the first frequency section. The overshoot section and the undershoot section may be included in the first frequency section. By adjusting the effective value in the first frequency section with a lower frequency, accuracy in adjustment of the effective value can be adequately assured.

In the above configuration, the first frequency section may include a first pulse section and a section pulse section. The first pulse section may be the first section of the waveform of the storage capacitor signal in the blanking interval. The second pulse section may be the last section of the waveform of the storage capacitor signal in the blanking interval. The first pulse section may include the overshoot section to equalize the effective values in the first pulse section and the second pulse section. Alternatively, the second pulse section may include the undershoot section. With this configuration, the accuracy in adjustment of the effective value can be adequately assured.

Each pixel may include a first sub-pixel and a second sub-pixel. The first sub-pixel may include a first transistor, a first pixel electrode connected to the first transistor, and a first storage capacitor. The second sub-pixel may include a second transistor, a second pixel electrode connected to the second transistor, and a second storage capacitor. Each data signal line and each scanning line may be connected to the first transistor and the second transistor in common. The storage capacitor line may include a first storage capacitor line connected to the first storage capacitor and a second storage capacitor line connected to the second storage capacitor. The storage capacitor drive circuit may be configured to generate a first storage capacitor signal applied to the first storage capacitor, and a second storage capacitor signal that is different in phase by 180 degrees from the first storage capacitor signal and applied to the second storage capacitor.

With this configuration, in a liquid crystal display device with a so-called multi-pixel technology, uneven brightness resulting from storage capacitor signals in a blanking period can be reduced with a simple method.

A method of driving a liquid crystal display device according to the present invention is provided for driving a liquid crystal display device that includes a plurality of data signal lines, a plurality of scanning signal lines, a plurality of pixels, a plurality of storage capacitor lines, and a storage capacitor drive circuit. The pixels are arranged close to respective intersections of the data signal lines and the scanning signal lines. The pixels include transistors, pixel electrodes connected to the transistors, and storage capacitors. The storage capacitor lines are connected to the respective storage capacitors. The storage capacitor drive circuit is configured to generate storage capacitor signals applied to the respective storage capacitors via the storage capacitor lines. The method includes: generating a waveform of each storage capacitor signal in a vertical blanking interval of image display; and driving the storage capacitor by the storage capacitor drive circuit using the storage capacitor signal in the vertical blanking interval. The waveform is a pulse waveform including an upper waveform region in which a signal level is higher than a mean voltage of the storage capacitor signal and a lower waveform region in which the signal level is lower than the mean voltage. The waveform of each storage capacitor signal includes at least one of an overshoot section in which the storage capacitor signal overshoots the maximum value of the pulse waveform and an undershoot section in which the storage capacitor signal undershoots the maximum value of the pulse waveform for equalizing effective values in the upper waveform region and in the lower waveform region.

The above method may further include: forming the waveform of each storage capacitor signal in the vertical blanking interval such that the waveform includes a first frequency section with a predetermined frequency and a second frequency section with a frequency higher than the frequency of the first frequency section; and including the overshoot section and the undershoot section in the first frequency section.

The above method may further include: forming the first frequency section to include a first pulse section and a second pulse section; and including the overshoot section in the first pulse section to equalize the effective values in the first pulse section and the second pulse section. The first pulse section is the first section of the waveform of the storage capacitor signal in the blanking interval. The second pulse section is the last section of the waveform of the storage capacitor signal in the blanking interval. Alternatively, the method may further include including the undershoot section in the second pulse section.

In the above method, each pixel may include a first sub-pixel and a second sub-pixel. The first sub-pixel may include a first transistor, a first pixel electrode connected to the first transistor, and a first storage capacitor. The second sub-pixel may include a second transistor, a second pixel electrode connected to the second transistor, and a second storage capacitor. Each data signal line and each scanning line may be connected to the first transistor and the second transistor in common. The storage capacitor line may include a first storage capacitor line connected to the first storage capacitor and a second storage capacitor line connected to the second storage capacitor. The storage capacitor drive circuit may be configured to generate a first storage capacitor signal applied to the first storage capacitor, and a second storage capacitor signal. The second storage capacitor signal is different in phase by 180 degrees from the first storage capacitor signal and applied to the second storage capacitor. The method may further include: driving the first storage capacitor by the storage capacitor drive circuit with the first storage capacitor signal in the vertical blanking interval; and driving the second storage capacitor by the storage capacitor drive circuit with the second storage capacitor signal in the vertical blanking interval.

A method of adjusting a pulse waveform signal according to the present invention is provided for adjusting a pulse waveform signal that includes an upper waveform region in which a signal level is higher than a mean voltage and a lower waveform region in which the signal level is lower than the mean voltage. The method includes adjusting the pulse waveform signal, for equalizing effective values in the upper waveform region and in the lower waveform region in a predetermined period, to include at least one of an overshoot section in which the storage capacitor signal overshoots the maximum value of the pulse waveform in a part of the predetermined period and an undershoot section in which the storage capacitor signal undershoots the maximum value of the pulse waveform in a part of the predetermined period in the predetermined period.

With this configuration, if the pulse waveform signal is a storage capacitor signal in the liquid crystal display device and the predetermined period is a vertical blanking interval in the liquid crystal display device, effective values in the upper waveform section and the lower waveform section of a storage capacitor signal in the vertical blanking interval can be equalized. Therefore, uneven brightness resulting from the storage capacitor signal in the blanking interval can be reduced with a simply method.

### Advantageous Effect of the Invention

As described above, according to the present invention, adjustments of effective values of the pulse waveform signal in the predetermined period can be adequately conducted. Therefore, uneven brightness resulting from the storage capacitor signal in the blanking interval can be reduced with a simple method.

### BRIEF DESCRIPTION OF THE DRAWINGS

FIG. 1 is a schematic configuration diagram of a liquid crystal display device according to the present invention.

FIG. 2 is a circuit diagram illustrating a configuration of the liquid crystal display device for one pixel.

FIG. 3 is a time chart illustrating waveforms of a storage capacitor signal and a gate signal according to a first embodiment.

FIG. 4 is a time chart illustrating waveforms of a storage capacitor signal and a gate signal according to a second embodiment.

FIG. 5 is a time chart illustrating waveforms of a storage capacitor signal and a gate signal according to a conventional technology.

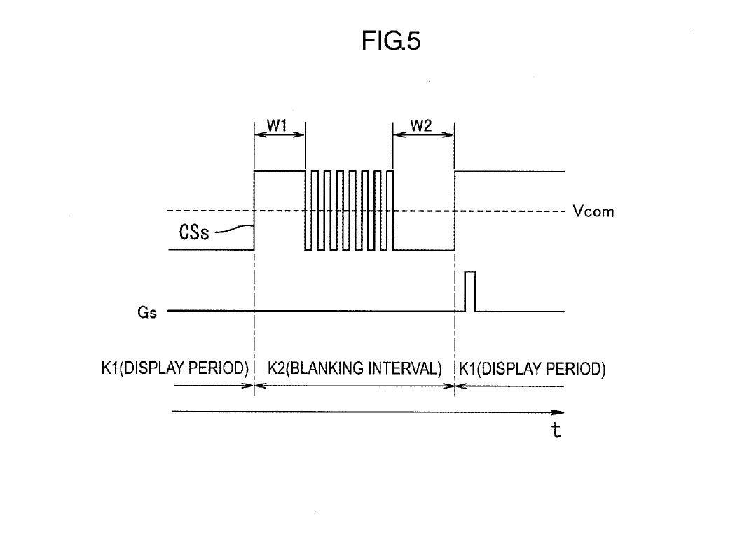

### MODE FOR CARRYING OUT THE INVENTION

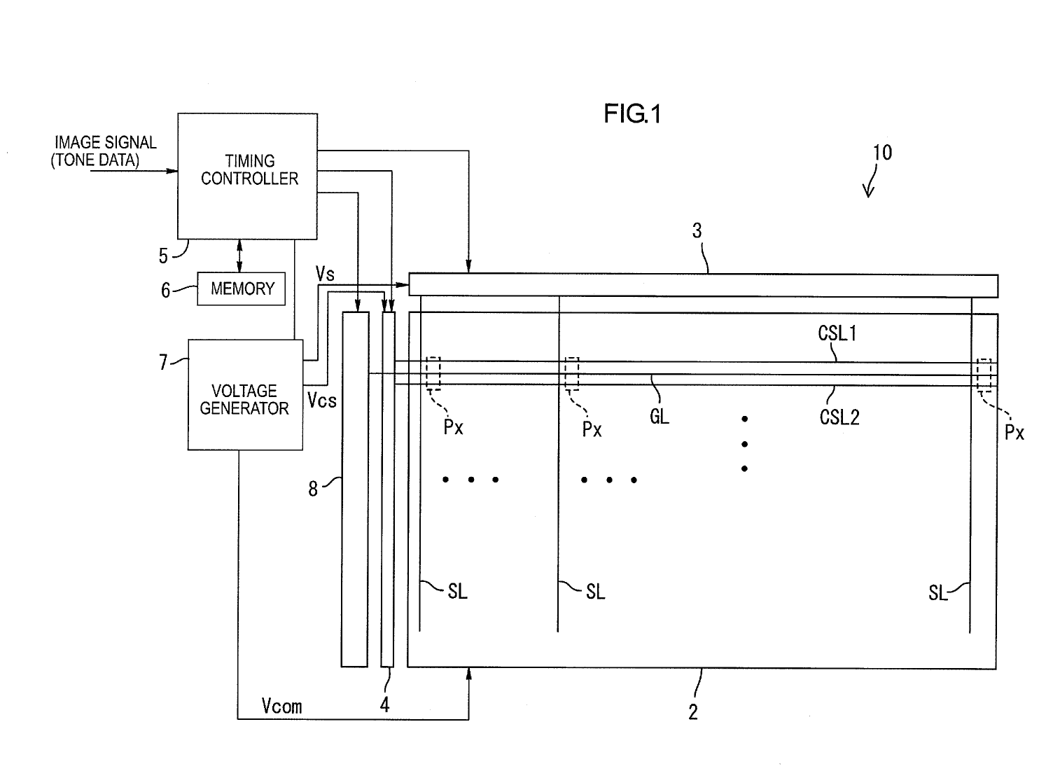

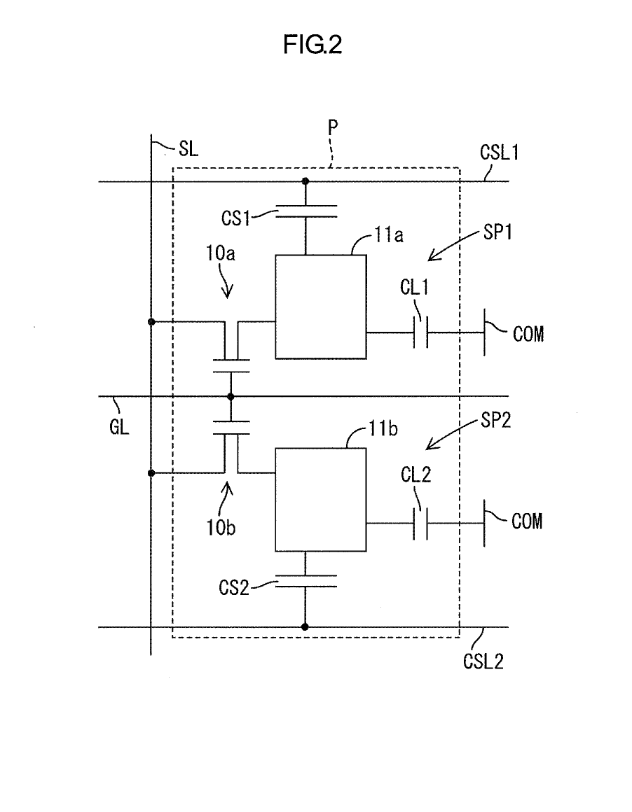

A first embodiment will be explained with reference to FIGS. 1 to 4. FIG. 1 is a block diagram illustrating a schematic configuration of a liquid crystal display device 10 according to this embodiment. FIG. 2 is a circuit diagram illustrating a configuration of the liquid crystal display device 10 for one pixel.

As illustrated in FIG. 2, the liquid crystal display device 10 of this embodiment is a divided-domain type (so-called multi-domain technology) liquid crystal display device including pixels, each pixel Px of which is configured with sub-pixels SP1 and SP2. A divided-domain method is a method for improving a viewing angle dependency of a liquid crystal display device in terms of gamma characteristics (a difference in gamma characteristics between when the liquid crystal display device is viewed from the front and when it is viewed at an angle.

As illustrated in FIG. 1, the liquid crystal display device 10 includes a liquid crystal panel 2, a source driver 3, a storage capacitor (CS) drive circuit (hereinafter referred to as the CS drive circuit) 4, a timing controller 5, a memory 6, a voltage generator 7, and a gate driver 8. The liquid crystal display device 10 further includes a backlight unit (not illustrated).

The liquid crystal panel 2 includes two glass substrates (not illustrated), a component-side glass substrate with active components (TFT: thin-film transistor) and a filter-side glass substrate with filters. The liquid crystal panel 2 is a known active-matrix type liquid crystal panel that is alternately driven between positive polarity and negative polarity. The liquid crystal panel 2 is not limited to an active-matrix type liquid crystal panel.

The timing controller 5 generates signals including tone signals, polarity inversion signals, timing signals, and scanning start signals based on image signals (tone data) and synchronization signals. The tone signals and polarity inversion signals are supplied to the source driver 3. The timing signals are supplied to the CS drive circuit 4. The scanning start signals are supplied to the gate driver 8.

The memory 6 includes ROM, EEPROM (electronically erasable and programmable read only memory), and RAM.

The voltage generator 7 receives a predetermined source voltage from a power source (not illustrated). The voltage generator 7 generates voltages including voltages Vs, Vcs, and Vcom (an example of a mean voltage) based on the source voltage. The voltage Vs is provided to the source driver 3. The voltage Vcs is provided to the CS drive circuit 4. The Vcom is a common electrode potential supplied to a common electrode.

On the component-side glass substrate of the liquid crystal panel 2, data signal lines SL, scanning lines GL, first storage capacitor lines CSL1, second capacitor lines CSL2, and the pixels Px are arranged. The data signal lines SL and the scanning signal lines GL are perpendicular to each other. The pixels Px are arranged in matrix. The data signal lines SL are arranged in an upper layer than a layer in which the scanning signal lines GL are arranged. As illustrated in FIG. 1, the scanning signal lines GL extend in rows (the horizontal direction in FIG. 1) across the pixels Px. The data signal lines SL extend in columns (the vertical direction FIG. 1) along the pixels Px.

Each first storage capacitor line CSL1 is arranged on one of sides of the corresponding scanning signal line GL parallel to the scanning signal line GS. Each second storage capacitor line CSL2 is arranged on the other side of the scanning line GL parallel to the scanning line GL. The first storage capacitor lines CLS1 and the second storage capacitor lines CSL2 overlap the pixels Px. The CS drive circuit 4 supplies first storage capacitor signals CSs1, which are common signals, to the first storage capacitor lines CSL1 and second storage capacitor signals CSs2, which are common signals, to the second storage capacitor lines CSL2.

On the filter-side glass substrate of the liquid crystal panel 2, a common electrode is formed (not illustrated). A common voltage Vcom is applied to the common electrode and the common electrode holds a common electrode potential Vcom. The common electrode potential Vcom can be set to any value according to a liquid crystal drive system. For example, the common electrode potential Vcom may be set to +5V, a grand voltage (0V), or −5V.

In FIG. 2, an equivalent circuit of the liquid crystal display device illustrated in FIG. 1 for one pixel. As illustrated in FIG. 2, each pixel Px includes a first thin film transistor (TFT) 10a and a second TFT 10b, and a first pixel electrode 11a and a second pixel electrode 11b. The first pixel electrode 11a is arranged on one of sides of the scanning signal line GS (an upper side in FIG. 2). The second pixel electrode 11b is arranged on the other side of the scanning single line GS (a lower side in FIG. 2). Although not illustrated, the first pixel electrode 11a overlaps the first storage capacitor line CSL1 and the second pixel electrode overlaps the second storage capacitor line CSL2. The first transistor 10a and the second transistor 10b are arranged close to an intersection of the data signal line SL and the scanning signal line GL.

A source electrode of the first thin transistor 10a is connected to the data signal line SL, a drain electrode thereof is connected to the first pixel electrode 11a, and a gate electrode thereof is connected to the scanning signal line GS. In an overlapping area of the first pixel electrode 11a and the first storage capacitor line CSL1, a first storage capacitor CS1 is formed. In an overlapping area of the first pixel electrode 11a and the common electrode, a first pixel capacitor (liquid crystal capacitor) CL1 is formed.

A source electrode of each second thin film transistor 10b is connected to the corresponding data signal line LS, a drain electrode thereof is connected to the second pixel electrode 11b, a gate electrode thereof is connected to the corresponding scanning signal line GL. In an overlapping area of the second pixel electrode 11b and the second storage capacitor line CSL2, a second storage capacitor CS2 is formed. In an overlapping area of the second pixel electrode 11b and the common electrode, a second pixel capacitor (liquid crystal capacitor) CL2 is formed. In the liquid crystal display device 10, a first sub-pixel SP1 including the first pixel electrode 11a and a second sub-pixel SP2 including the second pixel electrode 11b are formed.

In the liquid crystal display device 10, signals with the same potential (tone voltages) are applied from the data signal line LS to the first pixel electrode 11a and the second pixel electrode 11b. Storage capacitor signals CSs1 and CSs2 are transmitted from the CS drive circuit 4 to the first storage line CSL1 and the second storage capacitor line CSL2, respectively. As a result, the first pixel electrode 11a and the second pixel electrode 11b are set at different potentials via the first storage capacitor CS1 and the second storage capacitor CS2.

With this configuration, in the liquid crystal display device 10, halftones can be expressed by area coverage modulations with the pixels Px each including a high-intensity sub-pixel (bright sub-pixel) and a low-intensity sub-pixel (dark sub-pixel). Therefore, the viewing angle dependency in terms of gamma characteristics (e.g., an excessively bright area) can be reduced.

### First Embodiment

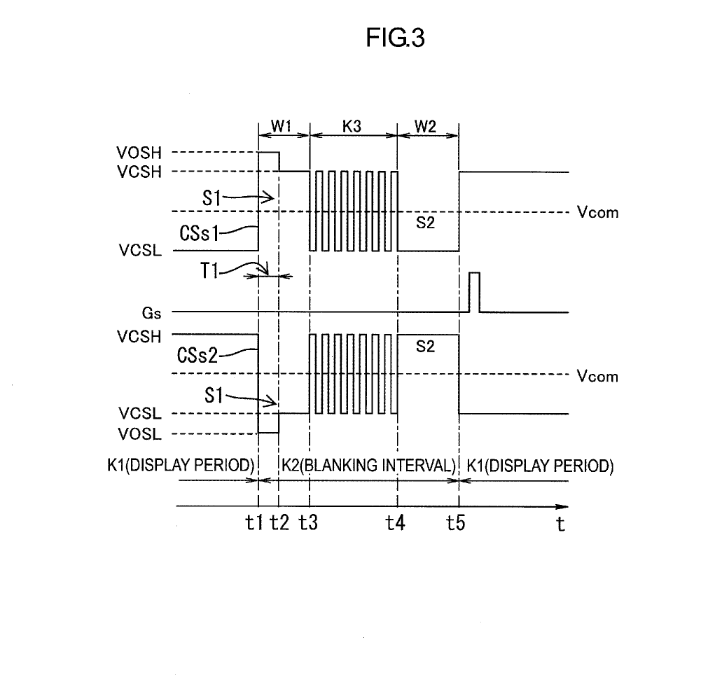

FIG. 3 is a time chart illustrating a waveform of the first storage capacitor signal CSs1, a waveform of the second storage capacitor signal CSs2, and a waveform of the scanning signal (gate-on-pulse) GS in the liquid crystal display device 10 of the first embodiment. The first storage capacitor signal CSs1 and a waveform of the second storage capacitor signal CSs2 are transmitted to the first capacitor line CSL1 and the second capacitor line CSL2, respectively. The scanning signal GS is transmitted to the scanning signal line GL. Specifically, FIG. 3 illustrates waveforms of the first storage capacitor signal CSs1 and the second storage capacitor signal CSs2 in a vertical blanking interval (hereinafter referred to simply as the blanking interval) K2 that is set for each display frame.

The waveform of the first storage capacitor signal CSs1 and the waveform of the second storage capacitor signal CSs2 are different from each other in phase by 180 degrees. Namely, the waveform of the second storage capacitor signal CSs2 is simply inverted in phase from the waveform of the first storage capacitor signal CSs1 with respect to the common electrode potential Vcom. Therefore, the second storage capacitor signal CSs2 will not be described. In this embodiment, the meaning of the phrase “to equalize the effective values” includes “to substantially equalize the effective values” and a phrase “the maximum value of the pulse waveform” means “the absolute value from the common electrode potential Vcom.”

As illustrated in FIG. 3, the first storage capacitor signal CSs1 has a waveform with a rising section of the rectangular wave in the blanking interval K2 overshot. Namely, at time t1 in FIG. 3, the first storage capacitor signal CSs1 has an overshoot potential VOSH when rises from a Low-side potential VCSL (corresponding to “the maximum value of the pulse waveform”), for example. Time t1 in FIG. 3 is time at which a display period K1 within a one-frame period ends and the blanking interval K2 starts. Time t1 in FIG. 3 is not limited to the same time as the time at which the blanking interval K2 starts. For example, time t1 may be a predetermined time after the time at which the blanking interval K2 starts.

Next, the voltage becomes a High-side potential VCSH (corresponding to “the maximum value of the pulse waveform”) at time t2 in FIG. 3. Then, the voltage falls to the Low-side potential VCSL at time t3 in FIG. 3. During a period from time t3 to time t4 in FIG. 3, the CS signal CSs1 is a pulse signal with a pulse width smaller than a width W1 from time t1 to time t3 in FIG. 3 and a signal level that periodically changes between the Low-side potential VCSL and the High-side potential VCSH.

During a period W2 from time t4 to time t5 in FIG. 3, the signal level of the first storage capacitor signal CSs1 is the Low-side potential VCSL and rises to the High-side potential VCSH at time t5. The time t5 in FIG. 3 is time at which the blanking interval K2 ends and the display period K1 of the next frame starts. The time t5 in FIG. 3 is not limited to the same time as the time at which the blanking interval K2 ends. For example, time t5 may be a predetermined time before the time at which the blanking interval K2 ends.

Namely, in the first embodiment, the first storage capacitor signal CSs1 includes a first frequency section (corresponding to the period W1 and the period W2) and a second frequency section (corresponding to the period K3). The frequency in the first frequency section is a predetermined frequency. The frequency in the second frequency section is higher than that in the first frequency section. In the first embodiment, the overshoot section (corresponding to the period T1) is in the first frequency section. The symmetry of the first storage capacitor signal CSs1 with respect to the common electrode potential Vcom in the period K3 is ensured. Namely, in the period K3, an effective value of the first storage capacitor signal CSs1 in a section higher than the common electrode potential Vcom (an upper waveform region) and an effective value thereof in a section lower than the common electrode potential Vcom (a lower waveform region) are equal. With the first frequency section and the second frequency section, the effective values can be properly adjusted and accuracy in effective value adjustment is adequately assured. The maximum value in the first frequency section and the maximum value in the second frequency section may be different from each other. The first frequency section and the second frequency section are not mandatory. The frequency of the first storage capacitor signal CSs1 in the blanking interval K2 may be constant.

The first storage capacitor signal CSs1 includes a first pulse section (corresponding to the period W1) and a second pulse section (corresponding to the period W2). The first pulse section is the first section of the waveform in the blanking interval K2. The second pulse section is the last section of the waveform in the blanking interval K2. The first pulse section W1 includes an overshoot section T1 to equalize effective values in the first pulse section and the second pulse section.

Specifically, the overshoot potential VOSH and the overshoot period T1 are defined such that, an area of a region S1 in which the voltage of the first storage capacitor signal CS1 is higher than the common electrode voltage Vcom in the period W1 is substantially equal to an area of a region S2 in which the voltage of the first storage capacitor signal CS1 is lower than the common electrode voltage Vcom. Even if the setting of the period K1 is limited by the scanning signal Gs, that is, by timing, the area of the region S1 and the area of the region S2 can be set equal by accurately setting the overshoot potential VOSH.

For example, if the period W2 is longer than the period W1 by 10 μs (microsecond), the common electrode potential Vcom is 0 V, and the High-side potential VCSH is 10 V, the overshoot area (T1×(VOSH−VCSH)) is 10 μs×10 V. Therefore, by setting the overshoot period T1 to 40 μs and the overshoot potential VOSH to 12.5 V, the area of the region S1 and the area of the region S2 can be set equal.

By setting the area of the region S1 and the area of the region S2 substantially equal, the effective values of the first storage capacitor signal CSs1 in the period W1 and the period W2 are set substantially equal. Namely, the effective values of the first storage capacitor line CSs1 in the blanking period K2 in the section in which the voltage is higher than the common electrode potential Vcom (the upper waveform region) and in the section in which the voltage is lower than the common electrode potential Vcom (the lower waveform region) are substantially equal. With this configuration, for liquid crystals that respond to the effective values, the first storage capacitor signal CSs1 substantially equally affect the liquid crystals in the periods W1 and W2, that is, in the upper waveform region and the lower waveform region. As a result, uneven brightness due to a collapse of the symmetry of the first storage capacitor signal CSs1 with respect to the common electrode potential Vcom in the blanking interval K2 is less likely to occur.

### Second Embodiment

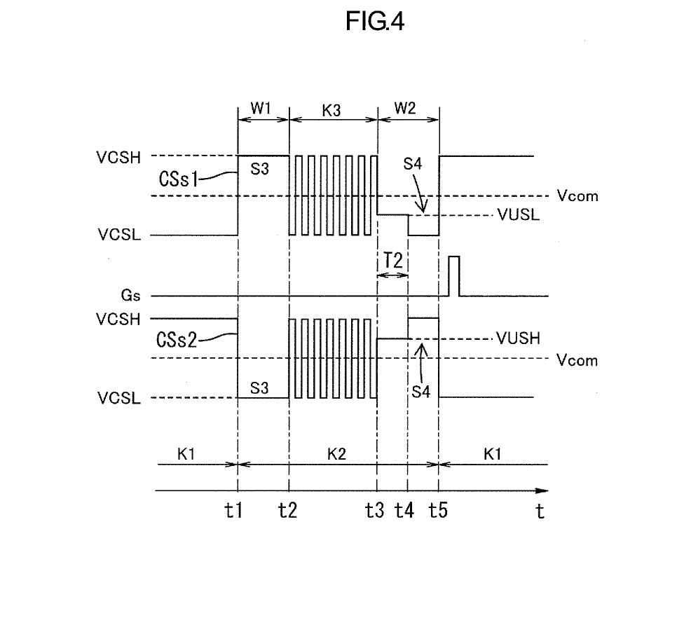

FIG. 4 is a time chart illustrating a waveform of a first storage capacitor signal CSs1, a waveform of a second storage capacitor signal CSs2, and a waveform of a scanning signal Gs according to a liquid crystal display device 10 of the second embodiment. Specifically, FIG. 4 illustrates waveforms of the storage capacitor signals CSs1 and CSs2 in a vertical blanking interval K2 similar to FIG. 3.

In the first embodiment, to set the area of the region S1 and the area of the region S2 substantially equal, the first capacitor signal CSs1 is overshot for the predetermined period T1 in the period W1. In the second embodiment, the first capacitor signal CSs1 undershoots for a predetermined period T2 in a period W2. Namely, in the second embodiment, to set effective values in the first pulse section (corresponding to the period W1) and the second pulse section (corresponding to the period W2) equal, the second pulse section W2 includes an undershoot section T2.

Specifically, an undershoot potential VUSL (or VUSH) and an undershoot period T2 for a period from time t3 to time t4 in FIG. 4 are set so that an area of a region S3 in which a voltage of the first storage capacitor signal CSs1 is higher than the common electrode potential Vcom in the period W1 and an area of a region S4 in which a voltage of the first storage capacitor signal CSs1 is lower than the common electrode potential Vcom are substantially equal.

Even if the setting of the period T2 is limited by the scanning signal Gs, similar to the setting of the period T1 in the first embodiment, that is, by timing, the area of the region S3 and the area of the region S4 can be set substantially equal by accurately setting the undershoot potential VUSL.

For example, if the period W2 is longer than the period W1 by 10 μs (microsecond), the common electrode potential Vcom is 0 V, and the Low-side potential VCSL is −10 V, the undershoot area (T2×(VUSL−VCSL)) is 10 μs×10 V. Therefore, by setting the undershoot period T2 to 50 μs and the undershoot potential VUSL to −8.0V, the area of the region S3 and the area of the region S4 are set equal.

With the first storage capacitor signal CSs1 undershot for the predetermined period T2, the area of the region S3 and the area of the region S4 can be set substantially equal. With this configuration, the effective values of the first storage capacitor signal CSs1 in the period W1 and the period W2 can be set substantially equal. Namely, for liquid crystals that respond to the effective values, the first storage capacitor signal CSs1 substantially equally affect the liquid crystals in the periods W1 and W2, that is, in the upper waveform region and the lower waveform region. As a result, uneven brightness can be properly suppressed.

### Effects of the Embodiment

When a waveform of a storage capacitance signal CSs in a blanking interval K2 set for a specific liquid crystal display device is applied (or adjusted) to a blanking interval K2 of another liquid crystal display device while maintaining a symmetry of the waveform with respect to a common electrode potential Vcom, the waveform of the storage capacitor signal CSs includes an overshoot section T1 or an undershoot section T2. Even if it is difficult to apply the storage capacitor signal CSs by timing adjustment with high accuracy due to limitation on signal timing, the waveform of the storage capacitor signal CSs can be easily applied to the blanking interval K2 of another liquid crystal display device by accurately setting the overshoot potentials VOSH, VOSL or the undershoot potentials VUSH, VUSL. As a result, the uneven brightness due to a collapse of the symmetry of the first storage capacitor signal CSs1 with respect to the common electrode potential Vcom in the blanking interval K2 can be properly suppressed.

### Other Embodiments

The present invention is not limited to the embodiment illustrated in the above description and the drawings. For example, the following embodiments may be included in the technical scope of the present invention.

(1) In the above embodiments, the present invention is applied to the divided-domain type liquid crystal display devices in which each pixel Px includes multiple sub-pixels SP1 and Sp2. However, an example of the present invention is not limited to such an example. The present invention can be applied to liquid crystal display devices that are not a divided-domain type with regular pixel configurations. The present invention can be applied to any liquid crystal display devices including pixels Px with storage capacitors CS and in which storage capacitor signals CSs are supplied to the storage capacitors CS.

(2) In the above embodiments, the first pulse section includes the overshoot section T1 of the second pulse section includes the undershoot section T2 so that the effective values in the first pulse section (corresponding to the period W1) and in the second pulse section (corresponding to the period W2) become equal. The first pulse section is the first section of the waveform of the storage capacitor signal CSs in the vertical blanking interval K2. The second pulse section is the last section of the waveform of the storage capacitor signal CSs in the vertical blanking interval K2. An example is not limited to such an example.

For example, the first pulse section may include the undershoot section T2 and the second pulse section may include the overshoot section T1. Alternatively, the first pulse section may include the overshoot section T1 and the second pulse section may include the undershoot section T2. The overshoot T1 can be included in either the first pulse section or the second pulse section and the undershoot T2 can be included in either the first pulse section or the second pulse section so that the effective values in the first pulse section and the second pulse section become equal.

(3) In the above embodiments, the storage capacitor signal CSs in the blanking interval K2 includes the first frequency section (corresponding to the period W1 and the period W2) in which the frequency is a predetermined frequency and the second frequency section (corresponding to the period K3) in which the frequency is higher than the frequency in the first frequency section. The first frequency section includes the overshoot section T1 and the undershoot section T2. An example is not limited to such an example. For example, the storage capacitor signal CSs in the blanking interval K2 may be a pulse wave with a predetermined constant frequency and any one of pulses may include an overshoot section T1 or an undershoot section T2. At least one of the overshoot section T1 and the undershoot section T2 may be included in the storage capacitor signal CSs in the blanking interval K2 so that the effective values of the storage capacitor line CSs in the blanking interval K2 in the upper waveform region and the lower waveform region are set equal.

(4) In the above embodiments, the pulse waveform signal is the storage capacitor signal in the liquid crystal display device and the predetermined period is the vertical blanking interval in the liquid crystal display device. An example is not limited to such an example. The present invention can be applied to a case in which a pulse waveform signal needs to be adjusted so that effective values in an upper waveform region and a lower waveform region in a predetermined period are set equal.

### EXPLANATION OF SYMBOLS

2: Liquid crystal panel, 3: Source driver, 4: Storage capacitance drive circuit, 5: Timing controller, 7: voltage generator, 8: Gate driver, 10: Liquid crystal display device, GL: Scanning signal line, SL: Data signal line, CSL: Storage capacitor line

1. A liquid crystal display device comprising:
a plurality of data signal lines;
a plurality of scanning signal lines;
a plurality of pixels arranged close to respective intersections of the data signal lines and the scanning signal lines, the pixels including transistors, pixel electrodes connected to the transistors, and storage capacitors;
a plurality of storage capacitor lines connected to the respective storage capacitors; and
a storage capacitor drive circuit configured to generate storage capacitor signals applied to the respective storage capacitors via the storage capacitor lines, wherein
a waveform of each storage capacitor signal in a vertical blanking interval of image display is a pulse waveform including an upper waveform region in which a signal level is higher than a mean voltage of the storage capacitor signal and a lower waveform region in which the signal level is lower than the mean voltage, and
the waveform of each storage capacitor signal includes at least one of an overshoot section in which the storage capacitor signal overshoots the maximum value of the pulse waveform and an undershoot section in which the storage capacitor signal undershoots the maximum value of the pulse waveform for equalizing effective values in the upper waveform region and in the lower waveform region.

2. The liquid crystal display device according to claim 1, wherein
the storage capacitor signal in the vertical blanking interval includes a first frequency section with a predetermined frequency and a second frequency section with a frequency higher than the frequency of the first frequency section, and
the overshoot section and the undershoot section are included in the first frequency section.

3. The liquid crystal display device according to claim 2, wherein
the first frequency section includes a first pulse section and a second pulse section, the first pulse section being the first section of the waveform of the storage capacitor signal in the blanking interval, the second pulse section being the last section of the waveform of the storage capacitor signal in the blanking interval, and
the first pulse section includes the overshoot section to equalize the effective values in the first pulse section and the second pulse section.

4. The liquid crystal display device according to claim 2, wherein
the first frequency section includes a first pulse section at and a second pulse section, the first pulse section being the first section of the waveform of the storage capacitor signal in the blanking interval, the second pulse section being the last section of the waveform of the storage capacitor signal in the blanking interval, and
the second pulse section includes the undershoot section such that the effective values in the first pulse section and the second pulse section are equal.

5. The liquid crystal display device according to claim 1, wherein
each pixel includes a first sub-pixel and a second sub-pixel,
the first sub-pixel includes a first transistor, a first pixel electrode connected to the first transistor, and a first storage capacitor,
the second sub-pixel includes a second transistor, a second pixel electrode connected to the second transistor, and a second storage capacitor,
each data signal line and each scanning line are connected to the first transistor and the second transistor in common,
the storage capacitor line includes a first storage capacitor line connected to the first storage capacitor and a second storage capacitor line connected to the second storage capacitor,
the storage capacitor drive circuit is configured to generate a first storage capacitor signal applied to the first storage capacitor, and a second storage capacitor signal that is different in phase by 180 degrees from the first storage capacitor signal and applied to the second storage capacitor.

6. A method of driving a liquid crystal display device including a plurality of data signal lines, a plurality of scanning signal lines, a plurality of pixels, a plurality of storage capacitor lines, and a storage capacitor drive circuit, the pixels being arranged close to respective intersections of the data signal lines and the scanning signal lines, the pixels including transistors, pixel electrodes connected to the transistors, and storage capacitors, the storage capacitor lines being connected to the respective storage capacitors, the storage capacitor drive circuit being configured to generate storage capacitor signals applied to the respective storage capacitors via the storage capacitor lines, the method comprising:
generating a waveform of each storage capacitor signal in a vertical blanking interval of image display, the waveform being a pulse waveform including an upper waveform region in which a signal level is higher than a mean voltage of the storage capacitor signal and a lower waveform region in which the signal level is lower than the mean voltage, the waveform of each storage capacitor signal including at least one of an overshoot section in which the storage capacitor signal overshoots the maximum value of the pulse waveform and an undershoot section in which the storage capacitor signal undershoots the maximum value of the pulse waveform for equalizing effective values in the upper waveform region and in the lower waveform region; and
driving the storage capacitor by the storage capacitor drive circuit using the storage capacitor signal in the vertical blanking interval.

7. The method of driving a liquid crystal display device according to claim 6, further comprising:
forming the waveform of each storage capacitor signal in the vertical blanking interval such that the waveform includes a first frequency section with a predetermined frequency and a second frequency section with a frequency higher than the frequency of the first frequency section; and
including the overshoot section and the undershoot section in the first frequency section.

8. The method of driving a liquid crystal display device according to claim 7, further comprising:
forming the first frequency section to include a first pulse section and a second pulse section, the first pulse section being the first section of the waveform of the storage capacitor signal in the blanking interval, the second pulse section being the last section of the waveform of the storage capacitor signal in the blanking interval; and
including the overshoot section in the first pulse section to equalize the effective values in the first pulse section and the second pulse section are equal.

9. The method of driving a liquid crystal display device according to claim 7, further comprising:
forming the first frequency section to include a first pulse section at and a second pulse section, the first pulse section being the first section of the waveform of the storage capacitor signal in the blanking interval, the second pulse section being the last section of the waveform of the storage capacitor signal in the blanking interval; and
including the undershoot section in the second pulse section such that the effective values in the first pulse section and the second pulse section are equal.

10. The method of driving a liquid crystal display device according to claim 6, wherein each pixel includes a first sub-pixel and a second sub-pixel, the first sub-pixel includes a first transistor, a first pixel electrode connected to the first transistor, and a first storage capacitor, the second sub-pixel includes a second transistor, a second pixel electrode connected to the second transistor, and a second storage capacitor, each data signal line and each scanning line are connected to the first transistor and the second transistor in common, the storage capacitor line includes a first storage capacitor line connected to the first storage capacitor and a second storage capacitor line connected to the second storage capacitor, the storage capacitor drive circuit is configured to generate a first storage capacitor signal applied to the first storage capacitor, and a second storage capacitor signal that is different in phase by 180 degrees from the first storage capacitor signal and applied to the second storage capacitor, the method further comprising:
driving the first storage capacitor by the storage capacitor drive circuit with the first storage capacitor signal in the vertical blanking interval; and
driving the second storage capacitor by the storage capacitor drive circuit with the second storage capacitor signal in the vertical blanking interval.

11. A method of adjusting a pulse waveform signal including an upper waveform region in which a signal level is higher than a mean voltage and a lower waveform region in which the signal level is lower than the mean voltage, the method comprising
adjusting the pulse waveform signal, for equalizing effective values in the upper waveform region and in the lower waveform region in a predetermined period, to include at least one of an overshoot section in which the storage capacitor signal overshoots the maximum value of the pulse waveform in a part of the predetermined period and an undershoot section in which the storage capacitor signal undershoots the maximum value of the pulse waveform in a part of the predetermined period in the predetermined period.
